(19) United States
(12) Patent Application Publication
(10) Pub. No.: US 2020/0346176 A1
(43) Pub. Date: Nov. 5, 2020

(54) STATIC MIXER, DISPENSING ASSEMBLY AND METHOD OF DISPENSING MULTI-COMPONENT MATERIAL FROM A DISPENSING ASSEMBLY

(71) Applicant: Sulzer Mixpac AG, Haag (CH)

(72) Inventor: Joachim SCHOECK, Winterthur (CH)

(21) Appl. No.: 16/758,237

(22) PCT Filed: Oct. 26, 2018
(86) PCT No.: PCT/EP2018/079440

§ 371 Date: Apr. 22, 2020

(30) Foreign Application Priority Data
Oct. 27, 2017 (EP) 17198855.3

(51) Int. Cl. B01F 5/06; B05B 7/04; B01F 15/00

(52) U.S. Cl. CPC B01F 5/0617; B05B 7/0408; B01F 2215/006; B01F 15/0087; B01F 2215/0039; B01F 5/0641

(57) ABSTRACT

A static mixer for mixing a multi-component material includes mixing segments arranged one after another along a longitudinal axis. Some of the mixing segments include elongate inlets arranged substantially parallel to one another and elongate outlets arranged parallel to one another, with a respective elongate inlet connected to a respective elongate outlet via a respective passage forming a flow path. The elongate outlets arranged such that an elongate extent is rotated by an angle of rotation of at least 45° about the longitudinal axis with respect to an elongate extent of the elongate inlets, with the elongate outlets being connected to inlets of directly adjacent mixing segments. A blocking element blocks a part of the flow paths between the elongate outlets and the elongate inlets.

### CROSS-REFERENCE TO RELATED APPLICATION

This application is a U.S. National Stage application of International Application No. PCT/EP2018/079440, filed Oct. 26, 2018, which claims priority to European Patent Application No. 17198855.3, filed Oct. 27, 2017, the contents of each of which are hereby incorporated herein by reference.

### BACKGROUND

### Field of the Invention

The present invention relates to a static mixer comprising a plurality of mixing segments for mixing a multi-component material. The invention further relates to dispensing assembly comprising a static mixer and a multi-component cartridge filled with respective materials, as well as to a method of dispensing multi-component material from a dispensing assembly.

### Background Information

Conventional static mixers, respectively, mixing tips, as they are also known as, are used to mix a multi-component material dispensed from a multi-component cartridge. Such static mixers are used in a plethora of fields of application ranging from industrial applications, such as the use of adhesives to bond structural components one to another, or as protective coatings for buildings or vehicles, to medical and dental applications, for example, to make dental molds.

The multi-component material is, for example, a two-component adhesive comprising a filler material and a hardener. In order to obtain the best possible mixing result, e.g. an adhesive having the desired bond strength, the multi-component material has to be thoroughly mixed.

For this purpose the static mixers comprise several mixing segments arranged one after the other that repeatedly divide and re-combine part flows of the multi-component material to thoroughly mix the multi-component material.

### SUMMARY

On mixing the multi-component material, the material remaining in the static mixer after the dispensing process is generally discarded as it remains in the static mixer. Depending on the field of application the multi-component material can be comparatively expensive and may only be used for one application at a time. This is particularly true, for example in the dental field, where only part of the multi-component material stored in the cartridge is used for one application/patient at a time with the remaining multi-component material being stored in the multi-component cartridge for future applications. Thus, the excessive use of large volumes of multi-component material remaining in a static mixer after a single use leads to unnecessary cost. U.S. Pat. No. 3,195,865A discloses a prior art interfacial surface generator that is configured to mix fluids of different viscosities. The interfacial surface generator comprises an arrangement of baffles having a diameter of 2 and a half inches (i.e. approximately 6.35 cm) and a length of 3 inches (i.e. approximately 7.62 cm) that are arranged in a glass pipe.

For this reason it is an object of the present invention to provide a static mixer that guides respective part flows of the multi-component material efficiently through individual mixing segments for a thorough mixing of the multi-component material, that enables a reduction in the amount of mixing material left behind in a static mixer and that can be produced in an as facile manner as possible.

This object is satisfied by a static mixer having the features described herein.

Such a static mixer for mixing a multi-component material comprises:

a plurality of mixing segments arranged one after another along a longitudinal axis of the static mixer,

wherein at least some of the plurality of mixing segments comprises at least three elongate inlets arranged at least substantially in parallel to one another and at least three elongate outlets arranged at least substantially in parallel to one another, with a respective elongate inlet being connected to a respective elongate outlet via a respective passage forming a flow path for the multi-component material, wherein the elongate outlets are arranged such that an elongate extent thereof is rotated by an angle of rotation of at least 45°, preferably of at least substantially 90°, about the longitudinal axis with respect to an elongate extent of the elongate inlets, with the elongate outlets being connected to inlets of directly adjacent mixing segments;
wherein at least one blocking element is arranged and configured to block off at least a part of one of the flow paths between one of the elongate outlets and one of the elongate inlets of the plurality of mixing segments arranged directly adjacent to one another. The invention is characterized in that the plurality of mixing segments are formed from a plastic.

Generally speaking the mixing segments described herein can be formed from a plastic such as a thermoplastic or a thermosetting polymer, e.g. in an injection molding process. Such mixing segments can be produced in facile, reproducible and cost effective manner with a much higher degree of accuracy than wood or metal mixers known from the prior art.

The use of at least three elongate inlets and elongate outlets provides a plurality of part flow paths along which the multi-component material can flow and be mixed. Increasing the number of flow paths within a mixing segment leads to an improvement of the mixing results achieved, since the respective part flows of the multi-component material are divided and re-combined more frequently into different part flow paths.

Thus, the static mixer is generally designed in order to achieve the best possible mixing results while using as small a volume of the respective material of the multi-component material as possible in order to limit the waste of multi-component material.

The changes in direction of extent of the part flows about the angle of rotation within the respective mixing segment lead to a distribution of flow components being present in each part flow of the multi-component material. One of these components is an outer flow component that comprises flow components flowing in a direction directed at least substantially in the direction of the longitudinal axis and that hence arrive faster than other flow components also present in each respective passage of the respective mixing segment at the next mixing segment, since they travel the shortest distance along the respective passage.

In this connection it should be noted that the flows of multi-component material generally have the same speed and that the terms fast, faster, slow and slower are used in the context of the present invention to indicate part flows that arrive faster or slower at certain points within the mixing segments than other part flows. The difference in times of the part flows arriving at points within the mixing segment are due to the different path lengths present at the passages of the respective mixing segments. For example, a part flow travelling along an outer side of the mixing segment essentially along the longitudinal axis will pass through the mixing segment faster than a part flow that is deflected from an elongate inlet present at an outer side via the passage to an elongate outlet present at an inner region of the mixing segment.

The at least one blocking element prevents part flows of material and thereby small fractions of unmixed multi-component material, i.e. the outer flow component, from flowing between the respective elongate inlets and elongate outlets of the static mixer and consequently from being dispensed.

This is achieved by deflecting at least the outer flow component away from the longitudinal axis by the at least one blocking element and hence increasing the distance at least some of the flow components present in each part flow and especially that of the outer flow component have to travel through the respective mixing segment.

It should be noted that the undesirable outer flow components are generally present in a direction directed at least substantially in the direction of the longitudinal axis and that hence travel through the respective mixing segment faster than other flow components also present in each respective passage. The blocking off of these flow components leads to a more homogenous mixing of the multi-component materials.

In this connection it should be noted that it is preferred if the at least one blocking element is arranged in the passage within the flow path such that it directs at least some of the flow of multi-component material away from the direction directed in the direction of the longitudinal axis such that it increases the flow distance at least some of the components present in the respective part flow of the multi-component material passing through the respective passage have to travel.

Preferably the at least one blocking element is arranged at an outer side of the static mixer. It has hitherto been found that the passages arranged within the mixing segment do not comprise single part flows that are directed generally along the longitudinal axis that may not be mixed on the passage through the static mixer, but rather only the passage present at the outer side of the mixing segments comprise such part flows. Thus, the at least one blocking element is arranged in those regions of the static mixer which require further improvement of the mixing to take place. Moreover, the provision of the blocking elements only at the outer sides of the respective mixing segments makes the respective static mixer simpler to manufacture, e.g. in an injection molding process.

It is preferred if the at least one blocking element is arranged within an outer flow path of the multicomponent material in order to direct a part of a flow of multi-component material away from entering one of the adjacent elongate inlets of the next outer flow path of the directly adjacent mixing segment. In this way the at least one blocking element slows down a fast part flow of material by deflecting it from the preferred flow path to an inner flow path present in the static mixer.

Advantageously at least two blocking elements are arranged at one mixing segment. It has been found that, in dependence on the particular multi-component material to be mixed, the provision of the blocking elements at only one mixing segment can be sufficient to improve the mixing results.

Preferably at least two blocking elements are arranged at the plurality of mixing segments, with the at least two blocking elements being arranged at different sides of the static mixer.

It is preferred if the at least one blocking element is arranged at one of the plurality of mixing segments arranged one after another in a row along the longitudinal axis of the static mixer that is not the first and/or the last mixing segment of the row. It has been found that some of the part flows of material arrive faster at the respective elongate outlet than others and by arranging the at least one blocking element after one or more mixing segments the faster flowing part flows can be slowed down significantly by being deflected onto one of the inner flow paths and thereby a more homogenous mixing result can be achieved.

Preferably an inlet area of the respective part of the elongate inlet blocked off by the at least one blocking element corresponds to at least approximately 1/N of the overall area of the respective elongate inlet, where N corresponds to the number of elongate inlets of the respective mixing segment. Additionally or alternatively an outlet area of the respective part of the elongate outlet blocked off by the at least one blocking element corresponds to at least approximately 1/N of the overall area of the respective elongate outlet, where N corresponds to the number of elongate outlets of the respective mixing segment. By selecting the area of the blocking element to correspond to a size corresponding essentially to a fraction of the number of elongate inlets or elongate outlets one can ensure that any outer flow components are deflected towards an inner region of the respective mixing segment.

Preferably a first extent of the respective passage in a direction in parallel to the elongate extent of the elongate inlet reduces in size between the elongate inlet and a constriction of the passage and a second extent of the respective passage in a direction in parallel to the elongate extent of the elongate outlet increases in size between the constriction and the elongate outlet; wherein the changes in size of the first and second extents and the respective position of the constriction lead to a distribution of flow components being present in the part flow of the multi-component material, wherein one of these components is an outer flow component that comprises flow components flowing in a direction directed at least substantially in the direction of the longitudinal axis of the static mixer; and wherein the at least one blocking element is configured to deflect at least some of said outer flow component of the part flow of the multi-component material in the region of the elongate inlet and/or in the region of the elongate outlet away from the direction of flow directed at least substantially in the direction of the longitudinal axis.

In this connection it should be noted that the mixing of material present in each flow path is further facilitated by compressing the size of the flow path in the first extent and by the subsequent increase in size of the flow path in the second extent. In this way the part flow is not only forced to compress and relax in one respective direction of flow only, but due to the blocking element is additionally guided in a plurality of directions of flow in the respective elongate inlet and outlet to further improve the mixing result.

Preferably a change in size of one of the first and second extents of the passage between the elongate inlet and the constriction and/or between the constriction and the elongate outlet is either step like or gradual. The blocking element can thus be provided at a plethora of kinds of designs of static mixers.

Advantageously the at least one blocking element extends transverse to the longitudinal axis. Such an extent of the blocking element is simple to form e.g. in an injection molding process.

It is preferred if at least one of the blocking elements is present at one of the elongate inlets and projects into the elongate outlet of the directly adjacent mixing segment. Additionally or alternatively at least one of the blocking elements is present at one of the elongate outlets and projects into the elongate inlet of the directly adjacent mixing segment. Such shapes are simple to manufacture.

Preferably the at least one blocking element comprises inclined surfaces configured and arranged to direct at least part of a part flow of multi-component material away from the respective elongate inlet and elongate outlet. In this way the blocking element can also be used as a guide means (guide) in order to deflect the part flow in a desired direction of flow.

In this connection it should be noted that the individual mixing segments of the series can be separate from one another, but preferably the individual mixing segments of the series are connected to one another and are especially integrally formed as one mixing element, for example in an injection molding process.

Advantageously the static mixer further comprises a housing accommodating said plurality of mixing segments, an outlet for dispensing mixed multi-component material, and inlets that are configured to be coupled to outlets of a multi-component cartridge.

In this connection it should be noted that at least one of the housing, the outlet and the inlets are formed of plastic. Generally speaking the plastic can be one of a thermoplastic, a thermosetting polymer and an elastomer which is used to form the respective component e.g. in an injection molding process.

In this connection it should be noted that an inner surface of the housing is complementary shaped to the outer shape of the mixing segments of the static mixer in such a way that the inner surface forms an at least substantially planar boundary of the passages present at the outer sides of the mixing segments.

It should further be noted that groups of mixing segments can be combined along the longitudinal axis to form the static mixer or a mixing element of a static mixer. In this embodiment, for example, 2 to 10 such groups each comprising 2 to 5 integrally formed mixing segments can be combined to form the static mixer. The respective groups of mixing segments can either be connected to one another or be separate from one another.

According to a further aspect the present invention further relates to a dispensing assembly. The dispensing assembly comprises:
a static mixer as discussed herein,
the multi-component cartridge filled with multi-component material; and/or
a dispensing device that can be actuated to dispense said multi-component material via the static mixer.

The advantages discussed in the foregoing in relation to the static mixer likewise hold true for the dispensing assembly in accordance with the invention.

The multi-component cartridge can thus be filled with materials selected from the group of members consisting of topical medications, medical fluids, wound care fluids, cosmetic and/or skin care preparations, dental fluids, veterinary fluids, adhesive fluids, disinfectant fluids, protective fluids, paints and combinations of the foregoing.

Such fluids and hence the dispensing assembly can therefore be expediently used in the treatment of target areas such as the nose (e.g. anti-histaminic creams etc.), ears, teeth (e.g. molds for implants or buccal applications (e.g. aphtas, gum treatment, mouth sores etc.), eyes (e.g. the precise deposition of drugs on eyelids (e.g. chalazion, infection, anti-inflammatory, antibiotics etc.), lips (e.g. herpes), mouth, skin (e.g. anti-fungal, dark spot, acne, warts, psoriasis, skin cancer treatment, tattoo removal drugs, wound healing, scar treatment, stain removal, anti-itch applications etc.), other dermatological applications (e.g. skin nails (for example anti-fungal applications, or strengthening formulas etc.) or cytological applications.

Alternatively the fluids and hence the dispensing assembly can also be used in an industrial sector, e.g. in the building industry, the automotive industry etc., for example, as adhesives, paints, and/or as protective coatings.

The static mixers described in the foregoing are hence configured for use with a cartridge dispensing assembly and are typically arranged to ensure a thorough through mixing of multi-component materials such as the ones discussed in the foregoing.

According to a further aspect the present invention further relates to a method of dispensing multi-component material from a dispensing assembly in accordance with the teaching presented herein. The method comprising:
actuating the dispensing device to urge the multi-component material stored in the multi-component cartridge into the static mixer and mixing the multi-component material in the static mixer, wherein at least some of one of the part flows of the multi-component material mixed in the static mixer is deflected away from the longitudinal axis by the at least one blocking element.

### BRIEF DESCRIPTION OF THE DRAWINGS

The invention will be explained in more detail hereinafter with reference to the drawings.

FIG. 1 is a perspective view of a dispensing assembly;

FIG. 2 is a perspective view of a mixing element of a static mixer;

FIGS. 3A-3D are respective side views of the mixing element of FIG. 2; and

FIG. 4 is a perspective view of a further mixing element.

In the following the same reference numerals will be used for parts having the same or equivalent function. Any statements made having regard to the direction of a component are made relative to the position shown in the drawing and can naturally vary in the actual position of application.

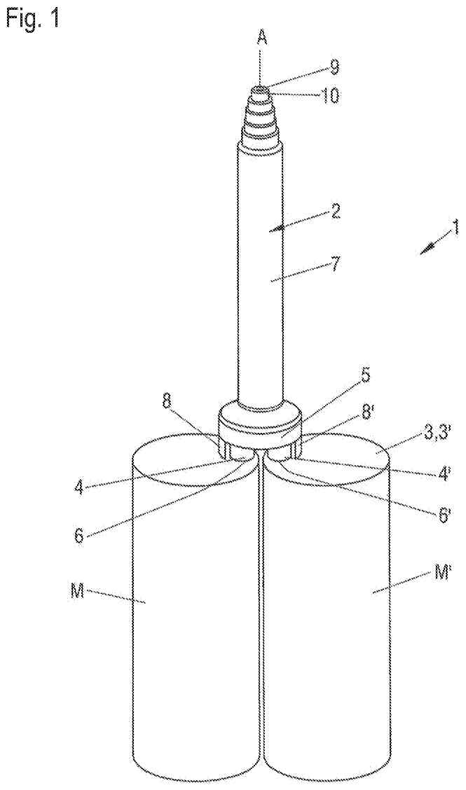

FIG. 1 schematically shows a dispensing assembly 1 comprising a static mixer 2 and a multi-component cartridge 3. The multi-component cartridge 3 shown in FIG. 1 is a two-component cartridge 3′ that is filled with respective two-component materials M, M′, for example, a hardener and a binder material.

The static mixer 2 comprises two inlets 4, 4′ at a first end 5 thereof. The two inlets 4, 4′ connect to outlets 6, 6′ of the two-component cartridge 3′. In the present example the inlets 4, 4′ receive the outlets 6, 6′ of the two-component cartridge 3′. It should be noted in this connection that other forms of interaction between the inlets 4, 4′ and the outlets 6, 6′ are possible.

A housing 7 of the schematically illustrated static mixer 2 further comprises an alignment means (alignment) 8, 8′ that enables correct alignment of the inlets 4, 4′ of the static mixer 2 relative to the outlets 6, 6′ of the two-component cartridge 3′. The alignment 8, 8′ can for example be configured as a bayonet-like connection means (bayonet-like connection) (not shown) and hence also act as a kind of an attachment means or device (not shown) to attach the static mixer 2 to the two-component cartridge 3′. Other kind of attachment devices (also not shown) such as a locking ring can also be used and are well known to the person skilled in the art.

The housing 7 further has a dispensing outlet 9 at a second end 10 of the static mixer 2. The mixed multi-component material M, M′ is dispensed via the dispensing outlet 9 following its passage through the static mixer 2. The dispensing outlet 9 is arranged at a longitudinal axis A of the static mixer 2. The longitudinal axis A extends from the inlets 4, 4′ of the static mixer 2 to the dispensing outlet 9 of the static mixer 2.

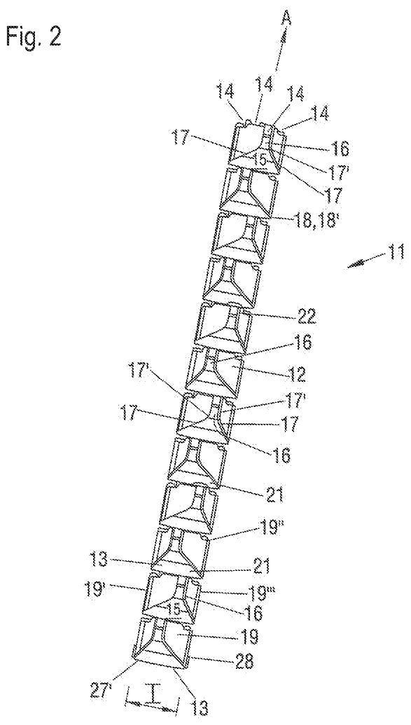

FIG. 2 shows a perspective view of a mixing element 11 of the static mixer 2. The mixing element 11 is composed of twelve mixing segments 12. The twelve mixing segments 12 are arranged in series one after another along the longitudinal axis A of the static mixer 2. Each mixing segment 12 comprises four elongate inlets 13 and four elongate outlets 14. The elongate outlets 14 of one mixing segment 12 are arranged next to the elongate inlets 13 of the next mixing segment 12 of the series.

In the present example two types of mixing segments 12 are provided that each have a very similar design. Every second mixing segment 12 is a second type of mixing segment that differs from the first type of mixing segment. The difference being that the respective elongate inlet 13 present at the outer side 19 of the first mixing segment leads to the left hand inner elongate outlet 14 and the elongate inlet 13 present at the outer side 19″ leads to the right hand inner elongate inlet 14 of the mixing segment 12. With regard to the second mixing segment 12 of the series the respective elongate inlet 13 present at the outer side 19 of the first mixing segment leads to the right hand inner elongate outlet 14 and the elongate inlet 13 present at the outer side 19″ leads to the left hand inner elongate inlet 14 of the mixing segment 12.

In the same way the inner elongate inlet 13 closest to the side 19 of the first mixing segment 12 leads to the elongate outlet 14 present at the outer side 19″′ whereas the inner elongate inlet 13 closest to the side 19″ of the first mixing segment 12 leads to the elongate outlet 14 present at the outer side 19′ and the inner elongate inlet 13 closest to the side 19 of the second mixing segment 12 leads to the elongate outlet 14 present at the outer side 19′ whereas the inner elongate inlet 13 closest to the side 19″ of the second mixing segment 12 leads to the elongate outlet 14 present at the outer side 19′″.

In this connection the difference between the configuration and arrangement of the first and second types of mixing segments 12 of the mixing element 11 is that the elongate outlets 14 of each second type of mixing segment 12 are rotated by 180° relative to the elongate outlets 14 of the first type of mixing segment 12 and the respective second type of mixing segment is then mirror imaged at a plane comprising the longitudinal axis A and the normal thereto extending from the side 19 of the drawing of FIG. 2.

The design of the mixing segments will be discussed in the following. It should be noted that the design of every second mixing segment 12 in the series of mixing segments is identical. The use of two types of mixing segments 12 that are of similar design ensures an improved mixing of the multi-component materials M, M′ by way of the corresponding mixing element 11.

The elongate inlets 13 of the twelve mixing segments 12 are arranged in parallel to one another. Likewise the elongate outlets 14 of the twelve mixing segments 12 are arranged in parallel to one another. In this connection it should be noted that slight deviations from a parallel arrangement are possible, for example, deviations by ±5° are possible.

A respective elongate inlet 13 of one mixing segment 12 is connected to a respective elongate outlet 14 of the same mixing segment 12 via a respective passage 15 to deflect respective part flows of the multi-component material from said elongate inlet 13 to said elongate outlet 14.

The elongate outlets 14 are arranged such that an elongate extent thereof is rotated by an angle of rotation of 90° about the longitudinal axis A with respect to an elongate extent of the elongate inlets 13. In this connection it should be noted that the longitudinal axis A extends from the elongate inlets 13 to the elongate outlets 14. In this connection it should be noted that slight deviations from an arrangement at exactly 90° are possible, for example, deviations by ±5° are possible.

A double headed arrow indicates a first extent I of the respective passage 15 in a direction in parallel to the elongate extent of the elongate inlet 13. The first extent I gradually reduces in size between the elongate inlet 13 and a constriction 16 of the passage 15. A second double headed arrow indicates a second extent O of the respective passage 15 in a direction in parallel to the elongate extent of the elongate outlet 14. The second extent O gradually increases in size between the constriction 16 and the elongate outlet 14.

In this connection it should be noted that the constriction 16 can be considered as a single point like transition between the first and second extents I, O in a plane extending in parallel to the elongate inlets 13 and elongate outlets 14 in which plane the first and second extents I, O have their respective smallest size.

Alternatively the constriction 16 can be configured as an overlap region in which both the first extent I and the second extent O respectively change in size in order to reduce and expand the respective part flows of materials M, M′ in the different directions corresponding to the elongate extents of the respective elongate inlets 13 and elongate outlets 14.

The gradual change in size of the first and second extents I, O of the respective passage 15 is formed by two walls 17 of the respective passage 15 that are inclined with respect to one another and with respect to the longitudinal axis A of the mixing segment 12. Moreover, the two walls 17 inclined with respect to one another are arranged opposite one another in order to directly face one another.

In this connection it can also be conceived that the constriction 16 is formed by walls that extend in parallel to the first and second extents I, O rather than the inclined walls 17 shown in the Figures. In this case the change in size of the respective passage 15 is not gradual, but rather step like.

When multi-component material M, M′ is guided in the respective passage 15, the material M, M′ present in each flow path is urged together between the respective elongate inlet 13 and the respective constriction 16 in the first extent I decreasing towards the respective constriction 16. Subsequently the material M, M′ present in each flow path is permitted to relax by the subsequent increase in size of the flow path in the direction of the second extent O. This constriction and expansion of the multi-component materials M, M′ takes place in different directions relative to the longitudinal axis A to improve the through mixing of the multi-component materials M, M′.

The first extent I and the second extent O are rotated by the same angle of rotation about the longitudinal axis A as is present between each respective elongate extent of the inlet 13 and elongate extent of the elongate outlet 14.

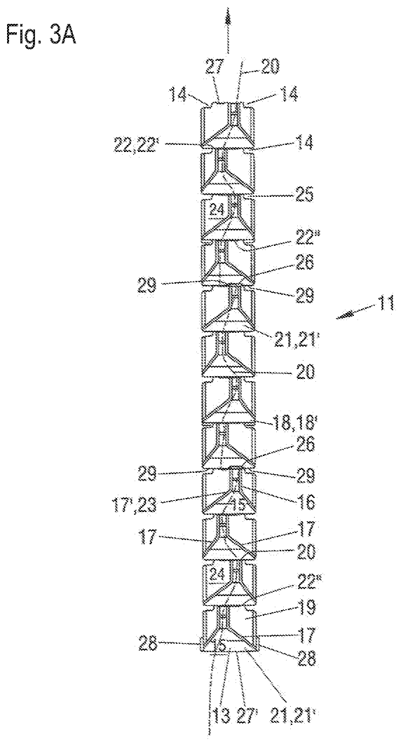

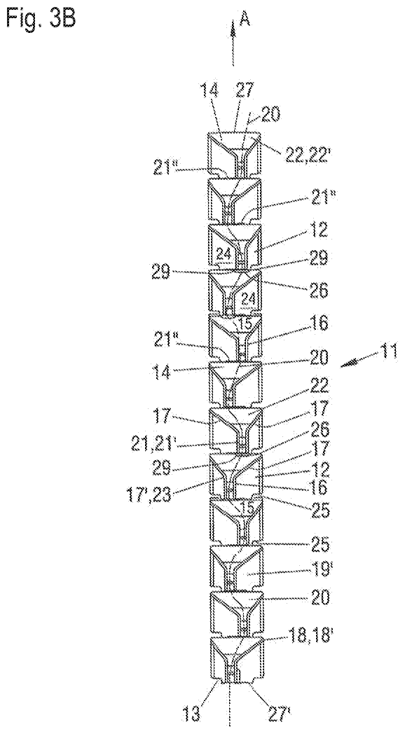

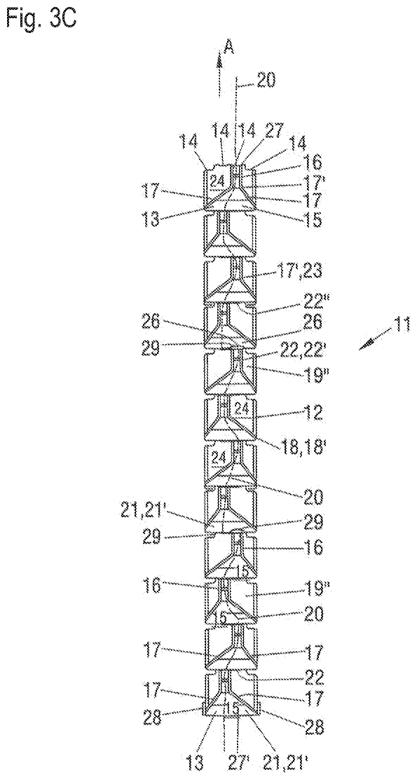

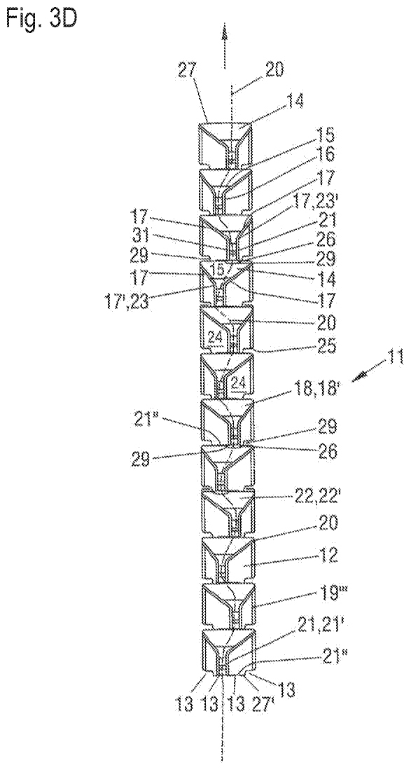

A transition 18 can further be seen in each passage 15 which is present between walls 17 of the passages 15 directly adjacent to further walls 21, 22 (see also FIGS. 3A to 3D in this regard). The transition 18 can be formed by a curved part surface 18′ or as a recess (not shown). It has namely been found that the provision of a curved part surface 18′ or a recess as a transition has beneficial effects on mixing and guiding the part flows of multi-component material M, M′ between the respective elongate inlets 13 and elongate outlets 14.

It should further be noted that an imaginary sleeve enveloping each mixing segment 12 at least generally has the shape of a cuboid. In this way each mixing segment 12 and hence the mixing element 11 has four sides 19, 19′, 19″, 19″′, as well as a top and a bottom side 27, 27′.

Two noses 28 can be seen at the bottom side 27′. The two noses 28 are provided as a type of insertion aid in such a manner that on inserting the mixing element 11 into the housing 7 of the static mixer 2, the correct alignment of the mixing element 11 relative to the housing 7 is achieved.

FIGS. 3A to 3D show respective views of the four sides 19, 19′, 19″, 19″′ of the mixing element 11 of FIG. 2. The walls 17 comprise curved part surfaces 17′ forming guide walls that are configured to direct the part flows of the multi-component material M, M′ from the respective elongate inlet 13 via the respective constriction 16 to the respective elongate outlet 14 of the respective mixing segment 12.

The changes in size of each passage 15 lead to a distribution of flow components being present in each part flow of the multi-component material M, M′ along the length of each of the twelve mixing segments 12 of the mixing element 11. One of these components is an outer flow component 20 (see FIGS. 3A to 3D) that comprises flow components flowing in a direction directed at least substantially in the direction of the longitudinal axis A of the static mixer 2.

In this connection it should be noted that the mixing segments 12 shown in FIG. 2 and the following are generally rectangular cuboids in which the height to side length ratios of the sides 19, 19′, 19″, 19′″ can be selected in the range of 0.7 to 0.9, i.e. for a mixing segment of 8 mm width the height in the longitudinal direction A can be 6.4 mm.

FIGS. 3A to 3D respectively indicate the outer flow component 20 for each of the part flows present at an outer side of the mixing element 11 by a dashed line. The respective outer flow component 20 extends essentially along the inner wall of the housing 7 at the outer side 19, 19′, 19″, 19″′ of the mixing element 11 and is less likely to be subjected to the mixing than the flow components extending through passages 15 present within other parts of the mixing segment 12.

In order to prevent this outer flow component 20 from passing through the static mixer 2 faster than the other components and thus not being mixed at all, some of the passages 15 of the mixing element 11 comprise a blocking element 26 arranged in the flow path either in the region of the elongate inlet 13 or in the region of the elongate outlet 14 of the respective mixing segment 12.

The blocking element 26 is configured to deflect at least some of said outer flow component 20 of the part flow of the multi-component material M, M′ in the region of the elongate inlet 13 or in the region of the elongate outlet 14 away from the direction of flow directed at least substantially in the direction of the longitudinal axis A in order to further improve the mixing results. This is indicated in the FIGS. 3A to 3D by breaks in the dotted line indicating the outer flow component 20. These breaks are present at the position of the respective blocking element 26.

The blocking element 26 is namely arranged at the respective passage 15 in order to ensure that each part flow of the multi-component material M, M′ arrives at a respective elongate outlet 14 at approximately the same time, and with approximately the same surface area.

Due to the varying geometries present within the respective passage 15 of the mixing segment 12 each part flow comprises flow components that pass through the mixing segment 12 faster than others. The blocking elements 26 are configured and arranged to slow down the faster components such that they arrive at the respective elongate outlet 14 in such a way that each respective part flow present in the respective passage 15 has a leading edge that extends at least approximately over the complete extent of the elongate outlet 14 and in parallel to the elongate outlet 14. Thus, in particular the outer flow component 20 of the part flow of the multi-component material M, M′ is slowed down by the provision of blocking elements 26 along the length of the mixing element 11. This is indicated in the respective FIGS. 3a to 3d where the dashed line stops at the respective blocking element 26.

The walls 21, 22 that separate the respective elongate inlets 13 and outlets 14 of each mixing segment 12 project from the body 24 of the mixing segment 12.

An inlet area of the respective part of the elongate inlet 13 blocked off by the respective blocking element 26 corresponds to at least approximately 1/N of the overall area of a respective inlet opening of the elongate inlet 13, where N corresponds to the number of elongate inlets 13 of the respective mixing segment 12. In the present example this means ¼ or approximately ¼ of the overall area is blocked off. If the mixing segment 12 was composed of three elongate inlets 13 then ⅓ or approximately ⅓ of the overall area would be blocked off. In this connection it is preferred if the inlet area blocked off is selected in the range of 0.5 to 16 mm². In the example of FIGS. 2 to 3D the inlet area corresponds to 2.2 mm².

Similarly an outlet area of the respective part of the elongate outlet 14 blocked off by the respective blocking element 26 corresponds to at least approximately 1/N of the overall area of a respective outlet opening of the elongate outlet 14, where N corresponds to the number of elongate outlets 14 of the respective mixing segment 12. In the present example this means ¼ or approximately ¼ of the overall area is blocked off. If the mixing segment 12 was composed of three elongate outlets 14 then ⅓ or approximately ⅓ of the overall area would be blocked off. In this connection it is preferred if the outlet area blocked off is selected in the range of 0.5 to 16 mm². In the example of FIGS. 2 to 3D the outlet area corresponds to 2.2 mm².

The respective blocking element that is present at one of the elongate inlets 13 projects into the respective elongate outlet 14 of the directly adjacent mixing segment 12. Similarly the respective blocking element 26 present at one of the elongate outlets 14 projects into the elongate inlet 13 of the directly adjacent mixing segment 12.

Each blocking element 26 comprises inclined surfaces 29 configured and arranged to direct at least part of a part flow of multi-component material M, M′ away from the respective elongate inlet 13 and elongate outlet 14.

In this connection it should be noted that an outer boundary of each elongate inlet 13 and elongate outlet 14 present at an outer side 19, 19′, 19″, 19″′ of the mixing segment 12 is formed by an internal wall (not shown) of the housing 7 of the static mixer 2.

It should further be noted that a thickness of each of the walls 21, 22 can be selected in the range of 0.12 to 1.5 mm, especially of 0.16 to 1.05 mm. In the examples shown in FIGS. 3a to 3d the walls 21, 22 have a thickness that corresponds to 0.52 mm.

It should further be noted that the walls 21, 22 have a height that projects from the body with the height being able to be selected in the range of 0.4 to 3 mm. In the examples shown in FIGS. 3A to 3D the walls 21, 22 have a height that corresponds to 0.8 mm.

In this connection it should be noted that each of the sides 19, 19′, 19″, 19″′ of the mixing segments 12 can have a width in the direction perpendicular to the longitudinal axis A selected in the range of 4 to 15 mm and in the example shown in FIGS. 3A to 3D have a width that corresponds to 8 mm.

Preferably a wall thickness of each of the walls 21, 22 is selected to be 3 to 10%, preferably of 4 to 7% of the width of the sides 19, 19′, 19″, 19″′.

In this connection it should be noted that each of the sides 19, 19′, 19″, 19″′ can have a height in the direction in parallel to the longitudinal axis A selected in the range of 4 to 15 mm and in the example shown in FIGS. 3A to 3D have a height that corresponds to 8 mm.

As indicated in FIGS. 3A to 3D the walls 17 forming the walls 17 inclined with respect to the longitudinal axis A respectively comprise a curved part surface 17′. The curved part surface 17′ extends towards the constriction 16 and hence is present in the region of the constriction 16.

The walls 17 inclined with respect to the longitudinal axis A extend from the outer sides 19, 19′, 19″, 19′″ towards the longitudinal axis A as straight part surfaces until they reach the transition 23 formed by the curved part surface 17′ that then leads to the planar surfaces 21′, 22′ formed by the respective walls 21, 22.

In this connection it should be noted that the radii of curvature of the curved part surface 17′ can generally be selected in the range of 0.2 to 0.3 times the width of the mixing segment 12, i.e. for an 8 mm wide mixing segment 12 the radii is selected in the range of 1.6 to 2.4 mm and in the examples of FIGS. 3A to 3D have a radius of curvature corresponding to at least approximately 2 mm.

It is further possible that the curved part surface 17′ is formed by a plurality of curved part surfaces 17′ each having different radii of curvature. In this event, the curved part surface 17′ having the largest radius of curvature is that curved part surface 17′ that is present within the respective constriction 16 and forms a transition 23 from the inclined wall 17 to a surface 21′, 22′ that extends at least substantially in parallel to the longitudinal axis A. The surfaces 21′, 22′ form part of one of walls 21, 22 of the respective elongate inlets and outlets 13, 14.

It should be noted in this connection that the walls 17 of the respective passage 15 inclined with respect to the longitudinal axis A can comprise at least two gradients if formed by respective straight part surfaces. The straight part surfaces then extend between one of the sides 19, 19′, 19″, 19′″ to the curved part surface 17′.

In this connection it should be noted that each of the gradients is selected in the range of 0.176 to 0.577, especially of 0.2 to 0.4. In this connection it should be noted that the gradient of the straight part surface of the wall 17 is defined as the change in height in the longitudinal direction A divided by the change in width of the respective side 19, 19′, 19″, 19″′ of the respective wall 17 and consequently is a dimensionless number.

The walls 21, 22 forming at least a part of one of the elongate outlets 14 and/or one of the elongate inlets 13 of the mixing segment 12 respectively project from a body 24 of the mixing segment 12. The walls 22 projecting from the body 24 and forming at least part of the elongate outlets 14 are arranged perpendicular to the walls 21 projecting from the body 24 that form at least part of the elongate inlets 13.

Some of the walls 21, 22 respectively projecting from the body 24 of the mixing segment 12 are connected to one another via a further wall 21″, 22″ at an outer side 19, 19′, 19″, 19′″ of the mixing segments. In this way some of the elongate inlets and outlets have three walls 21, 21″, 22, 22″ extending from the body 24. The further wall 21″, 22″ bridging the walls 21, 22 forming the respective planar surface 21′, 22′ each have a reduced wall thickness in comparison to the other walls 21, 22 of the same elongate inlet or outlet 13, 14. The walls 21″, 22″ bridging the walls 21, 22 are a part of the respective passage 15.

A cut-out 25 is respectively present in the region of the elongate inlets and outlets 13, 14 arranged at each of the outer sides 19, 19′, 19″, 19″′ of the mixing segment 12. The cut-out 25 is respectively provided in order to simplify a mold (not shown) that is used during the injection molding process used to manufacture the mixing element 11.

In this connection it should be noted that the cut-out 25 is present between the bodies 24 of directly adjacent mixing segments and the walls 21, 22 projecting from said bodies 24.

As discussed in the foregoing, the changes in size present in each of the passages 15 lead to a distribution of flow components being present in the part flow of the multi-component material M, M′.

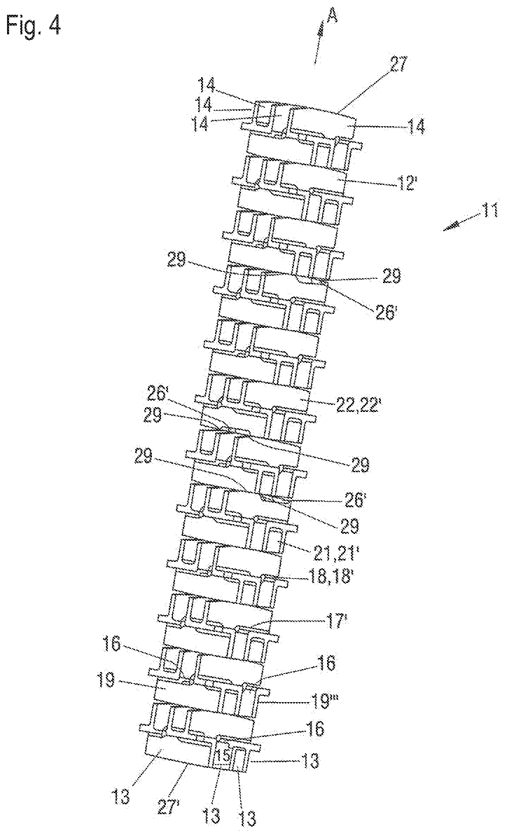

FIG. 4 shows a perspective view of a further mixing element 11′ that can be inserted into the housing 7 of the static mixer 2. In the design depicted in FIG. 4 each mixing segment 12′ has four elongate inlets 13 and four elongate outlets 14. The respective blocking element 26′ is arranged to extend from opposing walls 21, 22 of the respective passage 15 of the elongate inlets 13 or elongate outlets 14 of the directly adjacent mixing segment 12′. This is achieved by integrally forming the blocking element 26′ with said wall 21, 22 of the passage 15 of the mixing segment 12′.

In all of the embodiments shown the elongate inlets 13 and the elongate outlets 14 are arranged transverse to the longitudinal axis A. It should further be noted that in accordance with all of the depicted embodiments, all of the elongate inlets 13 and of the elongate outlets 14 are configured and arranged to deflect respective part flows of the multi-component material M, M′ from an elongate inlet 13 arranged at an inner region of the mixing element 11 of the static mixer 2 to an elongate outlet 14 arranged at an outer region of the mixing element 11 of the static mixer 2 and from an elongate inlet 13 arranged at the outer region of the mixing element 11 of the static mixer 2 to an elongate outlet 14 arranged at an inner region of the mixing element 11 of the static mixer 2.

It should further be noted that each elongate inlet 13 and each elongate outlet 14 shown in the foregoing has an opening having an at least generally rectangular shape.

It is preferred if the respective mixing segments 12, 12′ are formed in an injection molding process from a plastic material. Regardless of the method of manufacture of the mixing element 11, 11′ respectively of the mixing segments 12, 12′ the only space available within each of the mixing segments 12, 12′ is part of a respective flow path for the multi-component material M, M′ introduced into the static mixer 2 from the multi-component cartridge 3, 3′ discussed in the foregoing.

In this way the volume of the multi-component materials M, M′ remaining in the static mixer 2 after a dispensing process has taken place can be minimized as the dead space within the static mixers 2 are minimized in comparison to those available in the prior art. Moreover, the specific designs of the mixing segments 12, 12′ have been chosen to bring about an optimized mixing of the multi-component materials M, M′.

In this connection it should be noted that the various mixing segments 12, 12′ discussed in the foregoing to form the presented mixing elements 11, 11′ can also be mixed to form a mixing element (not shown) comprising a mixture of the various mixing segments 12, 12′ discussed and shown in the present application.

As is further visible in the view of the mixing element 11′, the walls 21, 22 of the passages 15 separating the respective elongate inlets 13 and/or elongate outlets 14 at a side of the mixing segment 12, 12″ have a convex shape in the direction of the longitudinal axis A. Such convex shapes enable a more simple tool to be used for the injection mold and hence facilitate the manufacture of the mixing segments 12, 12″ respectively of the corresponding mixing element 11′.

The respective blocking element 26, 26′ is arranged at an outer side 19, 19′, 19″, 19″′ of the respective mixing segment 12, 12′ in the region of the elongate inlet 13 or outlet 14 in order to direct a part of the outer flow component 20 of the multi-component material M, M′ away from entering one of the directly adjacent elongate inlets 13.

Some designs are possible that comprise two or more blocking elements 27 at one mixing segment 12″. In this case the two blocking elements 27 are preferably arranged at different sides 19, 19″, 19′, 19′″ of the mixing segment 12 (see e.g. FIG. 4).

Since the at least one blocking element 27 is arranged at a position within one of the flow paths for the multi-component material M, M′ such that it blocks a flow path present along a main direction of flow of the respective part flow of multi-component material M, M′, the at least one blocking element 27 is arranged at one of the plurality of mixing segments 12″ that is not the first and/or the last mixing segment of the series of mixing segments 12, 12″ forming the mixing element 11″.

As is further visible in the view of the mixing element 11″, the walls 21, 22 of the passages 15 separating the respective elongate inlets 13 and/or elongate outlets 14 at a side of the mixing segment 12, 12″ have a convex shape in the direction of the longitudinal axis A. Such convex shapes enable a simpler tool to be used for the injection mold and hence facilitate the manufacture of the mixing segments 12, 12″ respectively of the corresponding mixing element 11″.

The mixing elements 11, 11′ shown each comprise twelve mixing segments 12, 12′. In this connection it should be noted that the mixing element 11, 11′ can comprise between 2 and 50 mixing segments 12, 12′, with the number of mixing segments 12, 12′ being selected in dependence on the actual application of the static mixer 2. The respective mixing element 11, 11′ can be formed in one piece, as individual mixing segments 12, 12′ or groups of mixing segments 12, 12′. For example, 2 to 10 groups of 2 to 5 mixing segments 12, 12′ can be used to form the mixing element 11, 11′. The individual groups can then be connected to one another or remain separate on their insertion along the longitudinal axis A into the housing 7 of the static mixer 2.

The mixing element 11, 11′ may also comprise other forms of mixing segments differing in design to the ones shown in the present application. For example, wave like mixing segments, round mixing segments, rectangular mixing segments, mixing segments of static mixers sold under the trade name T-MIXER or QUADRO-MIXER by Sulzer Mixpac can be used in combination with the mixing segments 12, 12′ discussed in the foregoing to form the mixing element 11, 11″.

In this connection it should be noted that although the mixing segments 11, 11′ described in the foregoing have a square cross-section perpendicular to the longitudinal axis A, other kinds of cross-sections can be envisaged, e.g. rectangular, oval, round, square with rounded off edges or rectangular with rounded off edges etc.

1. A static mixer for mixing a multi-component material, the static mixer comprising:
a plurality of mixing segments arranged one after another along a longitudinal axis of the static mixer;
at least some of the plurality of mixing segments comprising at least three elongate inlets arranged at least substantially in parallel to one another and at least three elongate outlets arranged at least substantially in parallel to one another, with a respective elongate inlet being connected to a respective elongate outlet via a respective passage forming a flow path for the multi-component material, the elongate outlets being arranged such that an elongate extent thereof is rotated by an angle of rotation of at least 45° about the longitudinal axis with respect to an elongate extent of the elongate inlets, with the elongate outlets being connected to inlets of directly adjacent mixing segments of the plurality of mixing segments; and
at least one blocking element arranged and configured to block off at least a part of one of the flow paths between one of the elongate outlets and one of the elongate inlets of the plurality of mixing segments arranged directly adjacent to one another, the plurality of mixing segments being plastic.

2. The static mixer in accordance with claim 1, the plurality of mixing segments is one of a thermoplastic, and a thermosetting polymer.

3. The static mixer in accordance with claim 1, wherein the elongate outlets are arranged such that the elongate extent thereof is rotated by an angle of rotation of at least substantially 90° about the longitudinal axis with respect to the elongate extent of the elongate inlets.

4. The static mixer in accordance with claim 1, wherein the at least one blocking element is arranged at an outer side of the static mixer.

5. The static mixer in accordance with claim 1, wherein the at least one blocking element is arranged within an outer flow path of the multicomponent material to direct a part of a flow of multi-component material away from entering one of the adjacent elongate inlets of a next outer flow path of a directly adjacent mixing segment.

6. The static mixer in accordance claim 1, wherein the at least one blocking elements includes at least two blocking elements arranged at one mixing segment.

7. The static mixer in accordance with claim 1, wherein the at least one blocking elements includes at least two blocking elements arranged at the plurality of mixing segments, with the at least two blocking elements being arranged at different sides of the static mixer.

8. The static mixer in accordance with claim 1,
wherein the at least one blocking element is arranged at one of the plurality of mixing segments arranged one after another in a row along the longitudinal axis of the static mixer that is not a first or a last mixing segment of the row.

9. The static mixer in accordance with claim 1,
wherein an inlet area of a respective part of the elongate inlet blocked off by the at least one blocking element corresponds to at least approximately 1/N of an overall area of the respective elongate inlet, where N corresponds to a number of elongate inlets of the respective mixing segment.

10. The static mixer in accordance with claim 1,
wherein an outlet area of the respective part of a respective elongate outlet of a respective mixing segment blocked off by the at least one blocking element corresponds to at least approximately 1/N of the overall area of the respective elongate outlet, where N corresponds to a number of elongate outlets of the respective mixing segment.

11. The static mixer in accordance with claim 1,
wherein a first extent of the respective passage in a direction in parallel to the elongate extent of the elongate inlet reduces in size between the elongate inlet and a constriction of the respective passage and a second extent of the respective passage in a direction in parallel to the elongate extent of the elongate outlet increases in size between the constriction and the elongate outlet, the constriction in size and the increase in size of the first and second extents and a respective position of the constriction lead to a distribution of flow components being present in a part flow of the multi-component material, one of these components is an outer flow component that comprises flow components flowing in a direction directed at least substantially in a direction of the longitudinal axis of the static mixer; and
the at least one blocking element is configured to deflect at least some of the outer flow component of the part flow of the multi-component material in a region of the elongate inlet or in a region of the elongate outlet away from the direction of flow directed at least substantially in the direction of the longitudinal axis.

12. The static mixer in accordance with claim 11, wherein the one of the constriction in size of the first extent and the increase in size of the and second extent of the respective passage between the elongate inlet and the constriction or between the constriction and the elongate outlet is either step like or gradual.

13. The static mixer in accordance with claim 1, wherein the at least one blocking element extends transverse to the longitudinal axis.

14. The static mixer in accordance with claim 1, wherein the at least one blocking element is disposed at one of the elongate inlets and projects into the elongate outlet of the directly adjacent mixing segment.

15. The static mixer in accordance with claim 1,
wherein the at least one blocking element is disposed at one of the elongate outlets and projects into the elongate inlet of the directly adjacent mixing segment.

16. The static mixer in accordance with claim 1 wherein the at least one blocking element comprises inclined surfaces configured and arranged to direct at least part of a part flow of multi-component material away from the respective elongate inlet and elongate outlet.

17. The static mixer in accordance with claim 1,
further comprising a housing accommodating the plurality of mixing segments, an outlet configured to dispense mixed multi-component material, and inlets configured to be coupled to outlets of a multi-component cartridge.

18. The static mixer in accordance with claim 17, wherein at least one of the housing, the outlet and the inlets is plastic.

19. The static mixer in accordance with claim 1, wherein each of the mixing segments has a plurality of sides and each of the sides has a width in a direction perpendicular to the longitudinal axis selected in the range of 4 to 15 mm.

20. The static mixer in accordance with claim 19, wherein a plurality of walls bound the respective passages and a thickness of each of the walls is selected to be 3 to 10% of a width of the sides of the mixing segments in the direction perpendicular to the longitudinal axis.

21. The static mixer in accordance with claim 19, wherein each of the sides of the mixing segments has a height in the direction in parallel to the longitudinal axis selected in the range of 4 to 15 mm.

22. A dispensing assembly comprising:
the static mixer in accordance with claim 1,
a multi-component cartridge filled with the multi-component material; or
a dispensing device configured to be be actuated to dispense the multi-component material via the static mixer.

23. A method of dispensing the multi-component material from the dispensing assembly in accordance with claim 22, the method comprising:
actuating the dispensing device to urge the multi-component material stored in the multi-component cartridge into the static mixer and mixing the multi-component material in the static mixer, at least some of one of part flows of the multi-component material mixed in the static mixer being deflected away from the longitudinal axis by the at least one blocking element.
